(19) United States
(12) Patent Application Publication
(10) Pub. No.: US 2016/0050919 A1
(43) Pub. Date: Feb. 25, 2016

(54) ACETYL-COA CARBOXYLASE INHIBITOR HERBICIDE AND AUXIN HERBICIDE FORMULATIONS

(71) Applicant: Nufarm Americas, Inc., Alsip, IL (US)

(72) Inventors: Thomas Byrne, Raleigh, NC (US); Robert Bruss, Morrisville, NC (US)

(21) Appl. No.: 14/831,448

(22) Filed: Aug. 20, 2015

Related U.S. Application Data
(60) Provisional application No. 62/040,221, filed on Aug. 21, 2014.

(51) Int. Cl. A01N 43/02; A01N 43/76; A01N 39/02; A01N 37/40

(52) U.S. Cl. CPC A01N 43/02; A01N 37/40; A01N 43/76; A01N 39/02

(57) ABSTRACT

The disclosure is related to compositions containing a herbicide that is an inhibitor of acetyl CoA carboxylase wherein at least a proportion of the inhibitor is in the form of an ester, and at least an auxin herbicide wherein at least a proportion of the auxin herbicide is in acid form, and methods for their preparation and use.

This application claims priority under 35 U.S.C. 119 (e) to U.S. Provisional Patent Application Ser. No. 62/040,221, entitled “Acetyl-CoA Carboxylase Inhibitor Herbicide and Auxin Herbicide Formulations”, filed Aug. 21, 2014, the disclosure of which is hereby incorporated by reference in its entirety.

### BACKGROUND

A variety of herbicides are available for agrochemical products. These agrochemical products include compositions, for example formulation products, that may combine more than one active herbicide. Each of these herbicides may have a unique mode of action against undesirable vegetation and/or plant growth. Compositions containing multiple herbicides are beneficial because they are more effective in controlling a wide variety of undesirable vegetation and/or plant growth while eliminating the need for individual application of each herbicide.

The agrochemical product compositions may also contain other active ingredients such as insecticides or fungicides. The compositions may further include non-active ingredients or co-formulants. The non-active ingredients or co-formulants help improve shelf life of the compositions or formulations during storage, and further provide a simple and effective way to use the composition upon dilution in water or oil, and spray application.

Sometimes, the compositions or formulations having multiple active herbicides have limited shelf life due to degradation caused by functional groups present in other active ingredients such as co-herbicides, or non-active ingredients. For example, a class of herbicides such as aryloxyphenoxy propionic esters can act as inhibitors of acetyl-CoA carboxylase. An example of an aryloxyphenoxy propionic ester that is sensitive to the presence of certain co-herbicides and/or non-active ingredients is fenoxaprop ester such as fenoxaprop ethyl. The fenoxaprop ester when combined with appropriate co-herbicides can provide effective control of grassy weeds and other undesired vegetation. However, it has been observed that functional groups such as weak acids degrade fenoxaprop ester by catalyzing ester hydrolysis. In certain instances, the fenoxaprop ester formulation shelf life is inferior compared to a formulation where other co-herbicide or non-active ingredient that is causing degradation of fenoxaprop ester is absent. Therefore, use of herbicides such as fenoxaprop ester is limited as a co-herbicide in agrochemical compositions because of a reduced useful shelf life when formulated along with many other co-herbicides and/or non-active ingredients that have functional groups interfering with fenoxaprop ester's stability.

The present disclosure is directed toward overcoming one or more of the problems discussed above.

### SUMMARY

The present disclosure relates to a composition including at least a herbicide that is an inhibitor of acetyl CoA carboxylase wherein at least a proportion of the inhibitor is in the form of an ester, and at least an auxin herbicide wherein at least a proportion of the auxin herbicide is in acid form. In an embodiment, the acetyl CoA carboxylase inhibitor is an aryloxyphenoxy propionic acid or an ester thereof. In one embodiment, the aryloxyphenoxy propionic ester herbicide is a fenoxaprop ester. The composition can include at least an auxin herbicide. In an embodiment, the disclosure provides compositions that can further include non-active ingredients.

Other embodiments will become apparent from a review of the ensuing detailed description.

### DESCRIPTION

The references to certain embodiments made in the following description are considered illustrative only of the principles of the disclosure. Further, since numerous modifications and changes will readily be apparent to those skilled in the art, it is not intended to limit the disclosure to the exact composition and process shown as described herein. Accordingly, all suitable modifications and equivalents may be resorted to as falling within the scope of the disclosure and as defined by the claims that follow.

General terms used in any of the embodiments herein can be defined as follows, however, the meaning stated should not be interpreted as limiting the scope of the term per se.

The words “comprise”, “comprising”, “include” and “including” when used in this specification and in the following claims are intended to specify the presence of the stated features, components, or steps, but they do not preclude the presence or addition of one or more additional features, components, or steps thereof.

Unless defined otherwise, all technical and scientific terms used herein have the same meaning as commonly understood by one of ordinary skill in the art to which this invention belongs. As used herein, the term “about,” when used in reference to a particular recited numerical value, means that the value may vary from the recited value by no more than 1%. For example, as used herein, the expression “about 100” includes 99 and 101 and all values in between (e.g., 99.1, 99.2, 99.3, 99.4, etc.).

The term “at least a proportion” as used herein means any value greater than zero %. For example, 60% fenoxaprop ester means that the fenoxaprop ester material used to prepare the disclosed compositions, whether bought commercially or synthesized, has at least 60% fenoxaprop ester herbicide and the rest of the 40% comprise other compounds. The other compounds may comprise impurities from the fenoxaprop ester synthesis such as residual acid from the fenoxaprop ester synthesis or other by-products of the synthesis. Similarly, 99% fenoxaprop ester means that the fenoxaprop ester material used to prepare the disclosed compositions, whether bought commercially or synthesized, has at least 99% fenoxaprop ester herbicide and the rest of the 1% comprise other compounds. The other compounds may comprise impurities from synthesis or other by-products of the synthesis. Similarly, 98% dicamba acid means that the dicamba acid material used to prepare the disclosed compositions, whether bought commercially or synthesized, has at least 98% dicamba acid herbicide and the rest of the 2% comprise other compounds.

The term “alkyl” as used herein refers to a hydrocarbon group having a general formula CₙH₂ₙ₊₁. Examples of alkyl include: methyl, ethyl, 1-propyl, 2-propyl, 1-butyl, and the like. Exemplary alkyls comprise one to ten carbon atoms, one to nine carbon atoms, one to eight carbon atoms, one to seven carbon atoms, one to six carbon atoms, one to five carbon atoms, one to four carbon atoms, one to three carbon atoms, one to two carbon atoms or one carbon atom.

The “wt %” or “weight percent” is based on the total weight of the composition.

In an embodiment, the disclosure relates to a composition comprising at least a herbicide that is an inhibitor of acetyl CoA carboxylase wherein at least a proportion of the inhibitor is in the form of an ester, and at least an auxin herbicide wherein at least a proportion of the auxin herbicide is in acid form. In a further embodiment, the disclosure provides that the herbicide that is an inhibitor of acetyl CoA carboxylase is an aryloxyphenoxy propionic acid or an ester thereof. In a further embodiment, the aryloxyphenoxy propionic ester herbicide is a fenoxaprop ester. In a further embodiment, the herbicide fenoxaprop ester is an optically active form or a racemic mixture. In a further embodiment, the herbicide fenoxaprop ester is fenoxaprop-p ethyl, fenoxaprop ethyl, or combination thereof.

The fenoxaprop ester herbicide is represented by the following structural formula I:

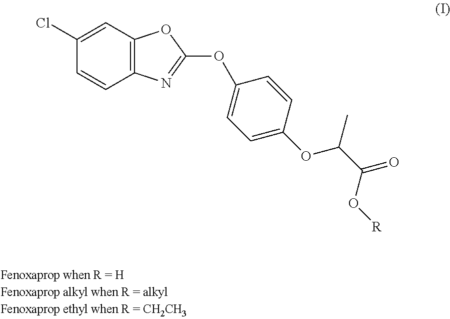

Other aryloxyphenoxy propionic ester herbicides that can be used according to the present disclosure include, but are not limited to, clodinafop-propargyl, cloquintocet, cyhalofop-butyl, diclofop-methyl, metamifop, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl or a combination thereof.

The composition includes at least an auxin herbicide wherein at least a proportion of the auxin herbicide is in acid form. In an embodiment, the auxin herbicide of the disclosed composition is a benzoic acid herbicide. In a further embodiment, the benzoic acid herbicide in the disclosed composition is dicamba, chloramben, or 2,3,6-trichlorobenzoic acid or a combination thereof. In yet another embodiment, the benzoic acid herbicide dicamba, chloramben, or 2,3,6-trichlorobenzoic acid or a combination thereof are in acid form.

The herbicides in acid form are usually more active. Even if herbicides are used in other forms such as their respective salt forms for improving water solubility, they still need to change forms back to their acid form for their herbicidal activity. Therefore, compositions comprising herbicides in acid form are preferred.

The composition can include a second auxin herbicide. In an embodiment, the second auxin herbicide is a carboxylic acid herbicide. In a further embodiment, the carboxylic acid herbicide is fluroxypyr acid or an ester thereof. In an embodiment, the herbicide fluroxypyr is in ester form. In an embodiment, the fluroxypyr ester is fluroxypyr MHE. In an embodiment, the second auxin herbicide is herbicide triclopyr acid or an ester thereof. In a further embodiment, the herbicide triclopyr is in acid form.

The composition can further include a third auxin herbicide. In an embodiment, the third auxin herbicide is a carboxylic acid herbicide. In a further embodiment, the carboxylic acid herbicide present as the third auxin herbicide in the composition is methylcholorophenoxy propionic acid (MCPP). In an embodiment, the herbicide MCPP is MCPP, MCPP-p or a combination thereof.

Non limiting examples of other auxin herbicides that can be used according to the present disclosure include 2,4-D, 2,4-DB, 2,4-DP, and MCPA.

A combination of an acetyl-CoA carboxylase inhibitor herbicide and at least an auxin herbicide provides a wide spectrum herbicide composition that can control a variety of undesired vegetation and/or plant growth. However, an acetyl-CoA carboxylase inhibitor such as fenoxaprop ethyl has limited stability in the presence of auxin herbicides such as benzoic acid herbicides and/or carboxylic acid herbicides, particularly when auxin herbicides are present in their acid form. To minimize degradation of fenoxaprop ethyl and improve the useful shelf life of compositions comprising fenoxaprop ethyl, and other acetyl-CoA carboxylase inhibitors, the disclosed compositions include non-active ingredients that improve overall stability of the compositions and minimizes degradation.

Other protonating agents besides herbicides in their acid form can also degrade acetyl-CoA carboxylase inhibitor herbicides such as fenoxaprop ethyl. The protonating agents may come from residual acids in co-herbicide esters or may be found in non-active ingredients. For example, aqueous solutions of ethyl lactate can degrade fenoxaprop ethyl. Without being bound by any theory, the experimental results suggest that the composition combinations disclosed herein help stabilize compositions comprising acetyl-CoA carboxylase inhibitor herbicides such as fenoxaprop ethyl by preventing degradation by acid catalyzed hydrolysis.

In an embodiment, the disclosure provides a composition comprising at least a herbicide in its ester form that is an acetyl CoA carboxylase inhibitor, and at least an auxin herbicide in its acid form. In a further embodiment, the composition comprises a second auxin herbicide in its ester form. In a further embodiment, the composition comprises optionally at least a surfactant; optionally at least a polar aprotic solvent; optionally at least an amide of a fatty acid; and optionally at least an antifreeze.

In an embodiment, the disclosure provides a composition consisting of at least a herbicide in its ester form that is an acetyl CoA carboxylase inhibitor, and at least an auxin herbicide in its acid form, a second auxin herbicide in its ester form, optionally at least a surfactant, optionally at least a polar aprotic solvent, optionally a second polar aprotic solvent, optionally at least an amide of a fatty acid, and optionally at least an antifreeze.

In an embodiment, the disclosure provides a composition consisting essentially of at least a herbicide in its ester form that is an acetyl CoA carboxylase inhibitor, and at least an auxin herbicide in its acid form, a second auxin herbicide in its ester form, optionally at least a surfactant, optionally at least a polar aprotic solvent, optionally a second polar aprotic solvent, optionally at least an amide of a fatty acid, and optionally at least an antifreeze.

In an embodiment, the disclosure provides a composition comprising at least a herbicide in its ester form that is an acetyl CoA carboxylase inhibitor, wherein the herbicide in its ester form is present in range from about 1.8 to about 3.2 wt % or from about 2.0 to about 3.0 wt %, and at least an auxin herbicide in its acid form in the range from about 1.8 to about 4.4 wt % or from about 2.0 to about 4.0 wt %. In a further embodiment, the composition comprises a second auxin herbicide in its ester form in the range from about 2.7 to about 5.5 wt % or from about 3.0 to about 5.0 wt %. In a further embodiment, the composition comprises a surfactant in the range from about 8.1 to about 12.1 wt % or from about 9 to about 11 wt %; a polar aprotic solvent in the range from about 8.1 to about 12.1 wt % or from about 9 to about 11 wt %; an amide of a fatty acid in the range from about 8.1 to about 12.1 wt % or from about 9 to about 11 wt %; and an antifreeze in the range from about 8.1 to about 12.1 wt % or from about 9 to about 11 wt %.

In an embodiment, the disclosure provides a composition comprising: about 2.0 to about 3.0 wt % fenoxaprop-p ethyl, about 3.0 to about 5.0 wt % fluroxypyr MHE, about 2.0 to about 4.0 wt % dicamba, at least a surfactant, at least a polar aprotic solvent, at least an amide of a fatty acid, and at least an antifreeze. In a further embodiment, a surfactant is present in the range from about 9 to about 11 wt %; a polar aprotic solvent is present in the range from about 9 to about 11 wt %; an amide of a fatty acid is present in the range from about 9 to about 11 wt %; and an antifreeze is present in the range from about 9 to about 11 wt %. In an embodiment, the disclosure provides a composition wherein the surfactant is a non-ionic surfactant. In an embodiment, the non-ionic surfactant is polyphenol ethoxylate, polymerized fatty acid ester, castor oil ethoxylate, PEG sorbitan oleate, or a combination thereof. In an embodiment, the non-ionic surfactant is polyphenol ethoxylate. In an embodiment, the polar aprotic solvent is NMP, DMSO, DMF, gamma-butyrolactone, or a combination thereof. In an embodiment, the composition comprises a second polar aprotic solvent. In an embodiment, the second polar aprotic solvent is present in the range from about 48 to about 52 wt %. In an embodiment, the second polar aprotic solvent is NMP, DMSO, DMF, gamma-butyrolactone, or a combination thereof. In an embodiment, the amide of a fatty acid is a morpholine amide, for example, blend of mixed alkyl chain amide comprising morpholine amide having density value of 0.90 g/cm³ (at 25° C.), flashpoint value of 135° C., viscosity value of 5 Cp, freeze/melting point value of less than −18° C. and boiling point value of 190° C. (Jeffsol AG-1732), morpholine amide of a C8,10 fatty acid (Jeffsol AG-1730), and/or alkyl amide, for example, N,N-dimethyloctaneamide and N,N-dimethyl-decanamide (Hallcomid M-8-10), N,N-dimethyldecanamide (Hallcomid M-10), N,N-dimethyloctaneamide and N,N-dimethyl-decanamide in 20% methyl ester (Hallcomid M-200), N,N-dimethyloctaneamide and N,N-dimethyl-decanamide in 40% methyl ester (Hallcomid M-400) or a combination thereof. In an embodiment, the amide of a fatty acid is blend of mixed alkyl chain amide comprising morpholine amide having density value of 0.90 g/cm³ (at 25° C.), flashpoint value of 135° C., viscosity value of 5 Cp, freeze/melting point value of less than −18° C. and boiling point value of 190° C. (Jeffsol AG-1732) or morpholine amide of a C8,10 fatty acid (Jeffsol AG-1730). In an embodiment, the antifreeze is propylene glycol, ethylene glycol, diethylene glycol, dipropylene glycol, hexalene glycol, or a combination thereof. In an embodiment, the antifreeze is propylene glycol.

Non-limiting examples of surfactants include ethoxylate alcohols, ethoxylate alky phenos, ethoxylated castor oils, ethoxylated fatty acids, ethoxylate fatty amines, ethoxylated fatty acid, EO/PO block copolymers, and fatty alcohol polyglycol ethers.

Non-limiting examples of polar aprotic solvents that can be used in the disclosed compositions are isophorone and acetophenone.

Non-limiting examples of antifreeze agents that can be used in the disclosed compositions are glycerin, glycerol, polyglycerols, and polyglycols.

In an embodiment, the disclosure provides a composition comprising at least a herbicide in its ester form that is an acetyl CoA carboxylase inhibitor and at least an auxin herbicide in its acid form. In a further embodiment, the composition comprises a second auxin herbicide in its acid form. In a further embodiment, the composition comprises a third auxin herbicide in its acid form. In a further embodiment, the composition comprises optionally at least a surfactant; optionally at least a polar aprotic solvent; optionally at least an amide of a fatty acid; and optionally at least an antifreeze.

In an embodiment, the disclosure provides a composition consisting of at least a herbicide in its ester form that is an acetyl CoA carboxylase inhibitor and at least an auxin herbicide in its acid form, a second auxin herbicide in its acid form, a third auxin herbicide in its acid form, optionally at least a surfactant, optionally at least a polar aprotic solvent, optionally a second polar aprotic solvent, optionally at least an amide of a fatty acid, and optionally at least an antifreeze.

In an embodiment, the disclosure provides a composition consisting essentially of at least a herbicide in its ester form that is an acetyl CoA carboxylase inhibitor and at least an auxin herbicide in its acid form, a second auxin herbicide in its acid form, a third auxin herbicide in its acid form, optionally at least a surfactant, optionally at least a polar aprotic solvent, optionally a second polar aprotic solvent, optionally at least an amide of a fatty acid, and optionally at least an antifreeze.

In an embodiment, the disclosure provides a composition comprising at least a herbicide in its ester form that is an inhibitor of acetyl CoA carboxylase, wherein the herbicide is present in range from about 0.45 to about 3.3 wt % or from about 0.5 to about 3.0 wt %, and at least an auxin herbicide in its acid form in the range from about 0.45 to about 3.3 wt % or from about 0.5 to about 3.0 wt %. In a further embodiment, the composition comprises a second auxin herbicide in its acid form in the range from about 0.45 to about 8.8 wt % or from about 0.5 to about 8.0 wt %. In a further embodiment, the composition comprises a third auxin herbicide in its acid form in the range from about 0.45 to about 2.2 wt % or from about 0.5 to about 2.0 wt %. In a further embodiment, the composition comprises a surfactant in the range from about 8.1 to about 14.3 wt % or from about 9 to about 13 wt %; a polar aprotic solvent in the range from about 8.1 to about 12.1 wt % or from about 9 to about 11 wt %; an amide of a fatty acid in the range from about 8 to about 20 wt % or from about 9 to about 11 wt %; and an antifreeze in the range from about 8.1 to about 12.1 wt % or from about 9 to about 11 wt %.

In an embodiment, the disclosure provides compositions comprising: about 0.5 to about 3.0 wt % fenoxaprop-p ethyl, about 0.5 to about 8.0 wt % triclopyr acid, about 0.5 to about 3.0 wt % dicamba, about 0.5 to about 2.0 wt % MCPP-p, at least a surfactant, at least a polar aprotic solvent, at least an amide of a fatty acid, and at least an antifreeze. In a further embodiment, the surfactant is present in the range from about 9 to about 13 wt %; the polar aprotic solvent is present in the range from about 9 to about 11 wt %; the amide of a fatty acid is present in the range from about 9 to about 11 wt %; and the antifreeze is present in the range from about 9 to about 11 wt %. In an embodiment, the disclosure provides compositions wherein the surfactant is a non-ionic surfactant. In an embodiment, the non-ionic surfactant is polyphenol ethoxylate, polymerized fatty acid ester, castor oil ethoxylate, PEG sorbitan oleate, or a combination thereof. In an embodiment, the non-ionic surfactant is polyphenol ethoxylate. In an embodiment, the polar aprotic solvent is NMP, DMSO, DMF, gamma-butyrolactone, or a combination thereof. In an embodiment, the composition comprises a second polar aprotic solvent. In an embodiment, the second polar aprotic solvent is present in the range from about 43 to about 57 wt % or from about 48 to about 52 wt %. In an embodiment, the second polar aprotic solvent is NMP, DMSO, DMF, gamma-butyrolactone, or a combination thereof. In an embodiment, the amide of a fatty acid is a morpholine amide, for example, blend of mixed alkyl chain amide comprising morpholine amide having density value of 0.90 g/cm³ (at 25° C.), flashpoint value of 135° C., viscosity value of 5 Cp, freeze/melting point value of less than −18° C. and boiling point value of 190° C. (Jeffsol AG-1732), morpholine amide of a C8,10 fatty acid (Jeffsol AG-1730), and/or alkyl amide, for example, N,N-dimethyloctaneamide and N,N-dimethyl-decanamide (Hallcomid M-8-10), N,N-dimethyldecanamide (Hallcomid M-10), N,N-dimethyloctaneamide and N,N-dimethyl-decanamide in 20% methyl ester (Hallcomid M-200), N,N-dimethyloctaneamide and N,N-dimethyl-decanamide in 40% methyl ester (Hallcomid M-400) or a combination thereof. In an embodiment, the morpholine amide of a fatty acid is Jeffsol AG-1732 or morpholine amide of a C8,10 fatty acid (Jeffsol AG-1730). In an embodiment, the antifreeze is propylene glycol, ethylene glycol, diethylene glycol, dipropylene glycol, hexalene glycol, or a combination thereof. In an embodiment, the antifreeze is propylene glycol.

The compositions of the present disclosure can be formulated in any formulation form, for example, emulsifiable concentrate, suspension concentrate, solution, capsule suspension, or oil dispersion. In an embodiment, the composition is formulated as a concentrate. In a further embodiment, the concentrate can be formulated as a microemulsion. In another embodiment, the concentrate can be combined with water to form a microemulsion.

The present disclosure also provides methods of preparing various formulation forms.

In an embodiment, the disclosure provides a method of preparing a concentrate, the method comprises combining at least a herbicide that is an inhibitor of acetyl CoA carboxylase wherein at least a proportion of the inhibitor is in the form of an ester, at least an auxin herbicide wherein at least a proportion of the auxin herbicide is in acid form, optionally at least a surfactant, optionally at least a polar aprotic solvent, optionally at least an amide of a fatty acid, and optionally at least an antifreeze, with optionally heating, and optionally shaking and/or stirring, to produce a concentrate. In a further embodiment, the concentrate can be combined with water to form a microemulsion.

In an embodiment, the disclosure provides a method of preparing a microemulsion, the method comprises preparing a concentrate comprising at least a herbicide that is an inhibitor of acetyl CoA carboxylase wherein at least a proportion of the inhibitor is in the form of an ester, at least an auxin herbicide wherein at least a proportion of the auxin herbicide is in acid form, optionally at least a surfactant, optionally at least a polar aprotic solvent, optionally at least an amide of a fatty acid, and optionally at least an antifreeze to produce a concentrate, and combining the concentrate with water to form a microemulsion.

The compositions of the present disclosure are stable for at least two weeks at a temperature up to 54° C. In an embodiment, the compositions of the present disclosure are stable up to 1 year at 25° C.

In an embodiment, the compositions of the present disclosure are stable at 40° C. for at least eight weeks.

In an embodiment, the compositions of the present disclosure are stable up to 1 month at 25° C., 2 months at 25° C., 3 months at 25° C., 4 months at 25° C., 5 months at 25° C., 6 months at 25° C., 8 months at 25° C., or 10 months at 25° C.

In an embodiment, the compositions of the present disclosure provide residual control of crabgrass. In an embodiment, the compositions of the present disclosure provide broad spectrum weed control. In an embodiment, the compositions of the present disclosure provide long lasting weed control. In an embodiment, the composition of the present disclosure can be used for post-emergent annual and perennial grass and broadleaf weed control in turf grass such as, for example, golf courses, athletic turf, commercial turf, and residential turf. The composition of the present disclosure can control actively growing grass weeds as well as large grass weeds. The composition of the present disclosure can be applied to turf grass species such as, for example, Kentucky bluegrass, perennial ryegrass, fine fescue, tall fescue, zoysia grass. The composition of the present disclosure can control grass weed species such as, for example, barnyard grass, Japanese stilt grass, foxtail species, pancium species, common/bermuda grass, Johnson grass (seedling), goose grass, sandbur, crabgrass (large), crabgrass (smooth), silver crabgrass, and sprangletop. The composition of the present disclosure can control broadleaf weed species such as, for example, bedstraw, dogfennel, lespedeza, sweetclover, buttercup, English daisy, mustards, thistle, burclover, Florida pusley, oxalis, vetch (common), carpetweed, geranium (Carolina), parsley piert, white clover, catsear, henbit, pennywort, wild carrot, chickweeds, hop clover, purslane (common), wild garlic, cudweed, knotweed, ragweed, wild onion, curly dock, lambs quarters, red (sheep), sorrel, and yarrow.

Illustratively, compositions provided herein can be used for post-emergence control of annual grass weeds. Further, compositions provided herein can be used for the suppression of perennial grass weeds in established turf grass. Still further, compositions provided herein can be used for the control of broadleaf weeds.

In some embodiments, compositions provided herein are absorbed through the foliage of grasses and broadleaf weeds.

The present disclosure provides a method for controlling undesired vegetation and/or plant growth, which comprises preparing a composition comprising at least a herbicide that is an inhibitor of acetyl CoA carboxylase wherein at least a proportion of the inhibitor is in the form of an ester, at least an auxin herbicide wherein at least a proportion of the auxin herbicide is in acid form, optionally at least a surfactant, optionally at least a polar aprotic solvent, optionally at least an amide of a fatty acid, and optionally at least an antifreeze, and applying an effective amount of the composition to the undesired vegetation and/or plants and/or their cultivation area.

Illustratively, a composition of the present disclosure can be applied to turfgrass at a range from about 1.3 to about 1.5 fluid ounces of the composition per 1000 square feet, or can be applied at a range from about 44 to about 88 gallons of finished spray solution per acre. The compositions can be applied using aerial and field spray techniques. Exemplary application techniques include pressurized hydraulic sprayer, handgun spray, or hand-held spray for spot treatment.

In an embodiment, a composition of the present disclosure can be applied as a tank mix with pre-emergent residual herbicides to provide residual annual weed control. For example, the composition can be applied at rates of 18.0 to 56 fluid ounces per acre (1.1 to 2.5 pints per acre)(0.6 to 1.75 quarts per acre) or 0.4 to 1.4 fluid ounces per 1,000 sq. ft. Compositions provided herein can be combined with other products such as, for example, PROCLIPSE®, BARRICADE®, DACTHAL®, DIMENSION®, PENDIMETHALIN®, TUPERSAN®, and RONSTAR® WP.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

### EXAMPLES

The following examples are provided such that those of ordinary skill in the art have a complete disclosure and description of how to make and use the methods and compositions of the invention, and are not intended to limit the scope of what the inventors regard as their invention. Efforts have been made to ensure accuracy with respect to numbers used (e.g., amounts, temperature, etc.) but some experimental errors and deviations should be accounted for. Unless indicated otherwise, parts are parts by weight and temperature is in degrees Centigrade.

### Example 1

A micro emulsion of fenoxaprop-p-ethyl, fluroxypyr, and dicamba was prepared at pH 6.7 as shown in Table 1.

TABLE 1

| Ingredients | wt % |
|---|---|
| Fenoxaprop-p-ethyl, 99% (CAS # 71283-80-2) | 2.85 |
| Fluroxypyr MHE, 97% (CAS # 81406-37-3) | 2.91 |
| Dicamba, 92% (CAS # 1918-00-9) | 3.07 |
| Sponto ME 404 (AkzoNobel Proprietary | 20.00 |
| Blend) | |
| Dimethylamine, 60% (CAS # 124-40-3) | 1.50 |
| Water | 16.88 |
| Purasolv EL, ethyl lactate (CAS # 687-47-8) | 48.00 |
| Purasolv EHL, ethylhexyl lactate (CAS # 687- | 5.0 |
| 47-8) | |

Method of preparation: In reactor 1, purasolve EL and EHL were combined followed by addition of fenoxaprop and fluroxypyr. The contents of reactor 1 were mixed followed by addition of Sponto. In another reactor 2, water and dicamba were combined followed by addition of dicamba and DMA. The contents of reactor 1 were combined with contents of reactor 2 to produce a combined mixture. The combined mixture was blended to obtain the composition described in table 1.

### Example 2

The formulation described in table 1 was tested for stability of all three active ingredients for two weeks at 54° C. Dicamba and fluroxypyr MHE remained unchanged. The fenoxaprop-p-ethyl almost degraded completely with only 1% recovered after two weeks at 54° C. Table 2 shows the stability of fenoxaprop-p-ethyl in the same formulation at ambient temperature (˜22° C.).

TABLE 2

| Initial | 2-week | 4-week | 6-week | 8-week | 12-week | 14-week |
|---|---|---|---|---|---|---|
| 2.82 | 2.61 | 2.24 | 2.15 | 1.91 | 1.28 | 0.87 |
| wt % | wt % | wt % | wt % | wt % | wt % | wt % |

### Example 3

An emulsifiable concentrate of fenoxaprop-p-ethyl, fluroxypyr, and dicamba was prepared as shown in Table 3.

TABLE 3

| Ingredients | wt % |
|---|---|
| Fenoxaprop-p-ethyl, 99% (CAS # 71283-80-2) | 3.24 |
| Fluroxypyr MHE, 97% (CAS # 81406-37-3) | 4.77 |
| Dicamba, 92% (CAS # 1918-00-9) | 3.49 |
| Toximul SEE-341 | 10.00 |
| NMP (CAS # 872-50-4) | 7.00 |
| Aromex WG 50 (Wintergreen fragrant) | 1.00 |
| Hallcomid M-200 | 70.50 |

The formulation described in table 3 was tested for stability of all three active ingredients for two weeks at 54° C. Dicamba and fluroxypyr MHE remained unchanged. The percent recovery of fenoxaprop-p-ethyl was 97.5% after two weeks at 54° C.

### Example 4

A liquid concentrate of fenoxaprop-p-ethyl, fluroxypyr, and dicamba was prepared as shown in Table 4.

TABLE 4

| Ingredients | wt % |
|---|---|
| Fenoxaprop-p-ethyl, 99% (CAS # 71283-80-2) | 2.73 |
| Fluroxypyr MHE, 97% (CAS # 81406-37-3) | 4.01 |
| Dicamba, 92% (CAS # 1918-00-9) | 2.94 |
| Polyoxyl phenol ethoxylate (TSP-60) | 10.00 |
| Jeffsol AG-1730 (CAS # 887947-29-7) | 10.00 |
| NMP (CAS # 872-50-4) | 10.00 |
| Propylene glycol USP grade (CAS # 57-55-6) | 10.00 |
| DMSO (CAS # 67-68-5) | 50.32 |

Method of preparation: In a reactor DMSO, Jeffsol, NMP, and glycol were combined followed by addition of Fenoxaprop-p-ethyl, Fluroxypyr MHE, and Dicamba. The contents of the reactor were mixed while heating to 54° C. until dissolved. Finally, Polyoxyl phenol ethoxylate was added to the reactor. The reactor contents were mixed to obtain the composition described in table 4.

The formulation described in Table 3 was tested for stability of all three active ingredients for two weeks at 54° C. All three active ingredients, i.e., fenoxaprop-p-ethyl, dicamba and fluroxypyr MHE remained unchanged meaning that the recovery of all three active ingredients was 100% after two weeks at 54° C.

### Example 5

An emulsion of fenoxaprop-p ethyl, triclopyr, dicamba, MCPP-p was prepared as shown in Table 5.

TABLE 5

| Ingredients | wt % |
|---|---|
| Fenoxaprop-p-ethyl, 99% (CAS # 71283-80-2) | 0.636 |
| Triclopyr ACID, 98% (CAS # 55335-06-3) | 1.298 |
| Dicamba, 92% (CAS # 1918-00-9) | 0.684 |
| MCPP-p, Wyke, 95% | 1.749 |
| TSP-60 | 12.5 |
| Jeffsol AG-1732 (CAS # 887947-29-7) | 15.00 |
| NMP (CAS # 872-50-4) | 10.00 |
| Propylene glycol USP grade (CAS # 57-55-6) | 10.00 |
| DMSO (CAS # 67-68-5) | 48.13 |

Table 6 shows stability data of all active ingredients.

TABLE 6

| | | % wt after 2 |
|---|---|---|
| Active Ingredient | Initial % wt | week at 54° C. |
| Fenoxaprop-p-ethyl | 0.60 | 0.60 |
| Dicamba | 0.64 | 0.45 |
| Triclopyr | 1.78 | 1.75 |
| MCPP-p | 1.53 | 1.39 |

The present invention is not to be limited in scope by the specific embodiments described herein. Indeed, various modifications of the invention in addition to those described herein will become apparent to those skilled in the art from the description. Such modifications are intended to fall within the scope of the appended claims.

What is claimed is:

1. A composition comprising at least a herbicide that is an inhibitor of acetyl CoA carboxylase wherein at least a proportion of the inhibitor is in the form of an ester, and at least an auxin herbicide wherein at least a proportion of the auxin herbicide is in acid form.

2. The composition of claim 1, wherein the herbicide that is an inhibitor of acetyl CoA carboxylase is an aryloxyphenoxy propionic acid or an ester thereof.

3. The composition of claim 2, wherein the herbicide aryloxyphenoxy propionic ester is a fenoxaprop ester.

4. The composition of claim 3, wherein the herbicide fenoxaprop ester is fenoxaprop-p ethyl, fenoxaprop ethyl, or combination thereof.

5. The composition of claim 1, wherein the auxin herbicide is a benzoic acid herbicide.

6. The composition of claim 5, wherein the benzoic acid herbicide is dicamba.

7. The composition of claim 6, where the dicamba is in acid form.

8. The composition of claim 1, further comprising at least a second auxin herbicide wherein the second auxin herbicide is a carboxylic acid herbicide.

9. The composition of claim 8, wherein the carboxylic acid herbicide is fluroxypyr acid or an ester thereof.

10. The composition of claim 9, where the fluroxypyr ester is fluroxypyr MHE.

11. The composition of claim 8, wherein the carboxylic acid herbicide is triclopyr acid.

12. The composition of claim 8, further comprising a third auxin herbicide wherein the third auxin herbicide is a carboxylic acid herbicide.

13. The composition of claim 12 wherein the carboxylic acid herbicide is methylcholorophenoxy propionic acid (MCPP).

14. The composition of claim 13, wherein MCPP is MCPP, MCPP-p or combination thereof.

15. The composition of claim 8, wherein the acetyl CoA carboxylase inhibitor is fenoxaprop-p ethyl, wherein the auxin herbicide is dicamba, and wherein the carboxylic acid herbicide is fluroxypyr MHE and wherein the herbicides are present in the range from:
about 2.0 to about 3.0 wt % fenoxaprop-p ethyl;
about 3.0 to about 5.0 wt % fluroxypyr MHE; and
about 2.0 to about 4.0 wt % dicamba.

16. The composition of claim 14, wherein the acetyl CoA carboxylase inhibitor is fenoxaprop-p ethyl, wherein the auxin herbicide is dicamba, wherein the carboxylic acid herbicide is triclopyr acid, and wherein the MCPP is MCPP-p, and wherein in the herbicides are present in the range from:
about 0.5 to about 3.0 wt % fenoxaprop-p ethyl;
about 0.5 to about 8.0 wt % triclopyr acid;
about 0.5 to about 3.0 wt % dicamba; and
about 0.5 to about 2.0 wt % MCPP-p.

17. The composition of claim 1, further comprising at least a surfactant.

18. The composition of claim 17, wherein the surfactant is a non-ionic surfactant.

19. The composition of claim 18, wherein the non-ionic surfactant is polyphenol ethoxylate, polymerized fatty acid ester, castor oil ethoxylate, PEG sorbitan oleate, or a combination thereof.

20. The composition of claim 1, further comprising at least a polar aprotic solvent.

21. The concentration of claim 20, wherein the polar aprotic solvent is selected from the group consisting of NMP, DMSO, DMF, gamma-butyrolactone, or a combination thereof.

22. The composition of claim 1, further comprising at least an amide of a fatty acid and at least an antifreeze.

23. The composition of claim 22, wherein the amide of a fatty acid is selected from the group consisting of a blend of mixed alkyl chain amide comprising morpholine amide having density value of 0.90 g/cm³ (at 25° C.), flashpoint value of 135° C., viscosity value of 5 Cp, freeze/melting point value of less than −18° C. and boiling point value of 190° C. (Jeffsol AG-1732), morpholine amide of a C8,10 fatty acid (Jeffsol AG-1730), and/or alkyl amide, for example, N,N-dimethyloctaneamide and N,N-dimethyl-decanamide (Hallcomid M-8-10), N,N-dimethyl-decanamide (Hallcomid M-10), N,N-dimethyloctaneamide and N,N-dimethyl-decanamide in 20% methyl ester (Hallcomid M-200), N,N-dimethyloctaneamide and N,N-dimethyl-decanamide in 40% methyl ester (Hallcomid M-400) or a combination thereof, and the antifreeze is selected from the group consisting of propylene glycol, ethylene glycol, diethylene glycol, dipropylene glycol, hexalene glycol, or a combination thereof.

24. The composition of claim 1, further comprising:
a surfactant present in the range from about 9 to about 13 wt %;
a polar aprotic solvent present in the range from about 9 to about 11 wt %;
an amide of a fatty acid present in the range from about 9 to about 11 wt %; and
an antifreeze present in the range from about 9 to about 11 wt %.

25. The composition of claim 24, further comprising a second polar aprotic solvent.

26. The composition of claim 25, wherein the second polar aprotic solvent is DMSO.

27. The composition of claim 26, wherein DMSO is present in the range from about 48 to about 52 wt %.

28. The composition of claim 1, wherein the composition is selected from the group consisting of emulsifiable concentrate, suspension concentrate, solution, or oil dispersion.

29. The composition of claim 1, wherein the composition is formulated as a microemulsion.

30. The composition of any of claim 1, wherein the composition is formulated as a concentrate.

31. A microemulsion comprising the concentrate of claim 30 and water.

32. The composition of claim 1, wherein the composition is stable for at least about two weeks at a temperature of at least about 54° C. or at least about 1 yr at about 25° C.
